(19) United States
(12) Patent Application Publication
(10) Pub. No.: US 2026/0217056 A1
(43) Pub. Date: Jul. 30, 2026

(54) Caster with Single Direction Automatic Alignment

(71) Applicant: Colson Group Holdings, LLC, Oakbrook Terrace, IL (US)

(72) Inventors: Jakob Berzins, Kalamazoo, MI (US); David Paul Beatty, Stevensville, MI (US)

(21) Appl. No.: 19/444,777

(22) Filed: Jan. 9, 2026

Related U.S. Application Data
(60) Provisional application No. 63/750,591, filed on Jan. 28, 2025.

(51) Int. Cl. B60B 33/00

(52) U.S. Cl. CPC B60B 33/006

(57) ABSTRACT

A caster has a mount, a fork that rotates about a swivel axis, a wheel rotatably mounted in the fork and an automatic alignment assembly adapted to pivot the fork and the wheel to a single, predetermined orientation relative to the mount. The automatic alignment assembly has a cross rod, a slider for sliding on the cross rod, a biasing member, and a camming member operatively connected to the mount. The camming member includes a cam post offset from the swivel axis with a curvilinear portion and a flat portion. When the fork is not in the single predetermined orientation, the cam surface of the slider is urged by the biasing member against the curvilinear portion of the cam post. When the fork is in the single predetermined orientation, the cam surface of the slider is urged by the biasing member against the flat portion of the cam post.

### RELATED APPLICATION DATA

This application claims priority benefit to U.S. provisional application Ser. No. 63/750591, filed Jan. 28, 2025, the disclosure of which is incorporated by reference.

### BACKGROUND

The present disclosure relates to a caster that is configured to automatically pivot its wheel to a single predetermined direction. The wheel is mounted in a fork that automatically pivots about a vertical or swivel axis relative to a mounting plate to a single predetermined position when the wheel is unloaded. The caster is particularly advantageous when it is used with carts that must have their wheels aligned for stacking.

In a particular embodiment disclosed herein, a horn, including a fork and a wheel, is provided with a cross rod disposed within an interior of the horn that is parallel to the axis of rotation of the wheel. A slider with a cam surface slides on the cross rod. The cam surface of the slider is urged against a cam post of a camming member with a coil spring. The cam post of the camming member is eccentrically mounted relative to a kingpin and thus the swivel axis of the caster. Thus, the automatic return of the pivoting wheel is effected solely by means of the coil spring working under compression against the slider and cam post.

### DESCRIPTION OF DRAWINGS

FIG. 1 is a perspective view of an exemplary caster.

FIG. 2 is a perspective sectional view of the caster of FIG. 1 showing detail of the automatic alignment assembly in an interior of a horn of the caster;

FIG. 3 is a partial perspective view of the caster of FIG. 1 with the wheel removed to show additional detail of the automatic alignment assembly in the interior of the horn of the caster;

FIG. 4 is a partial side sectional view of the caster of FIG. 1 showing further detail of the automatic alignment assembly in the interior of the horn of the caster;

FIG. 5 is a sectional bottom view of the caster of FIG. 1 showing further detail of the automatic alignment assembly in the interior of the horn of the caster;

FIG. 6 is a perspective view of a slider of the automatic alignment assembly of the caster of FIG. 1.

FIG. 7 is a perspective view of a camming member of the automatic alignment assembly;

FIG. 8 is an alternate perspective view of a camming member of the automatic alignment assembly of the caster of FIG. 1; and

FIG. 9 is a schematic representation showing the orientation of a cam post of the camming member relative to the slider when the wheel of the caster is not in the single predetermined position.

FIG. 10 is a schematic representation showing the orientation of the cam post of the camming member relative to the slider when the wheel of the caster is in the single predetermined position.

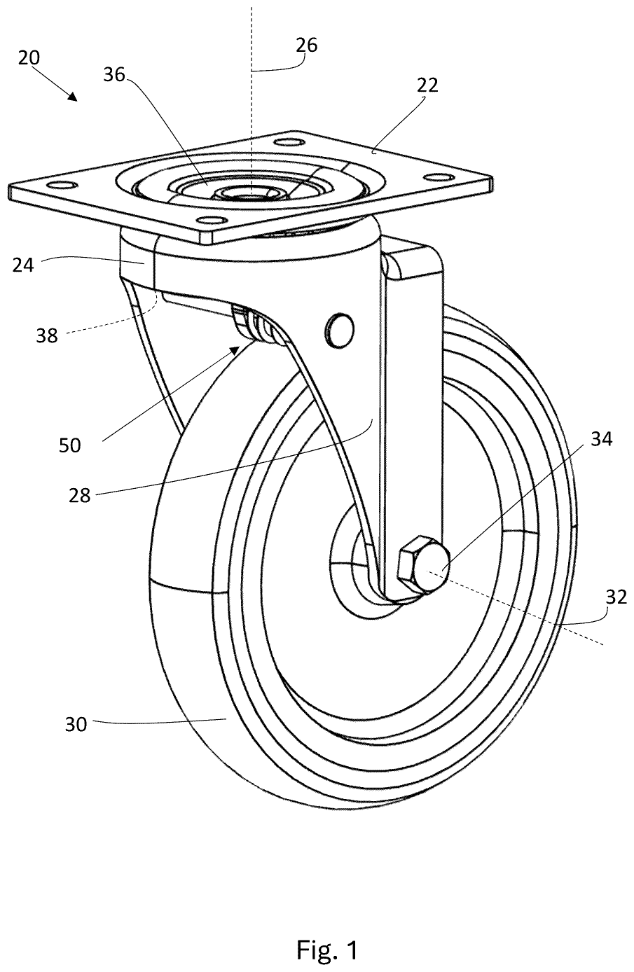

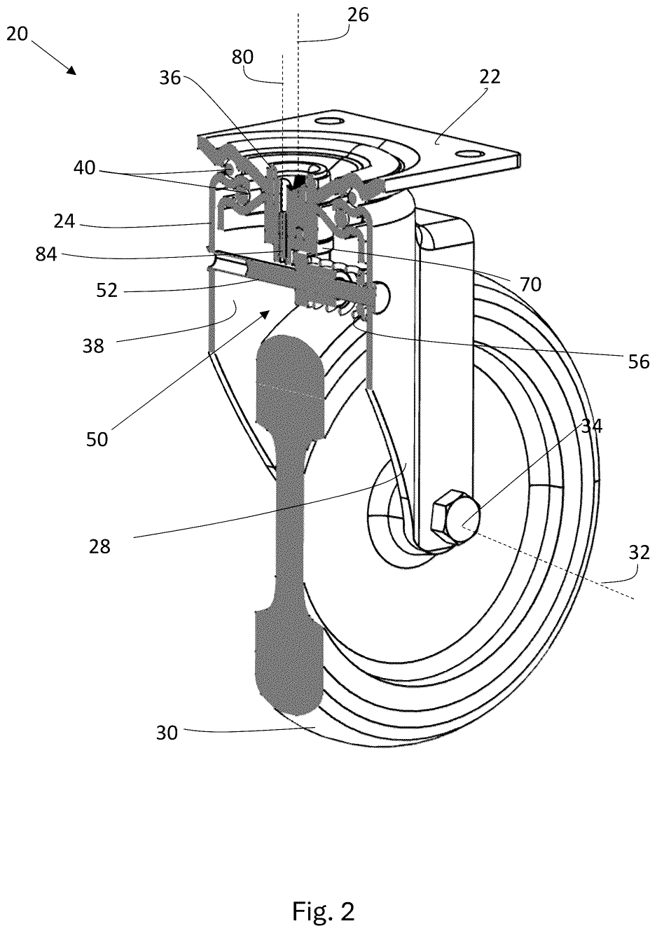

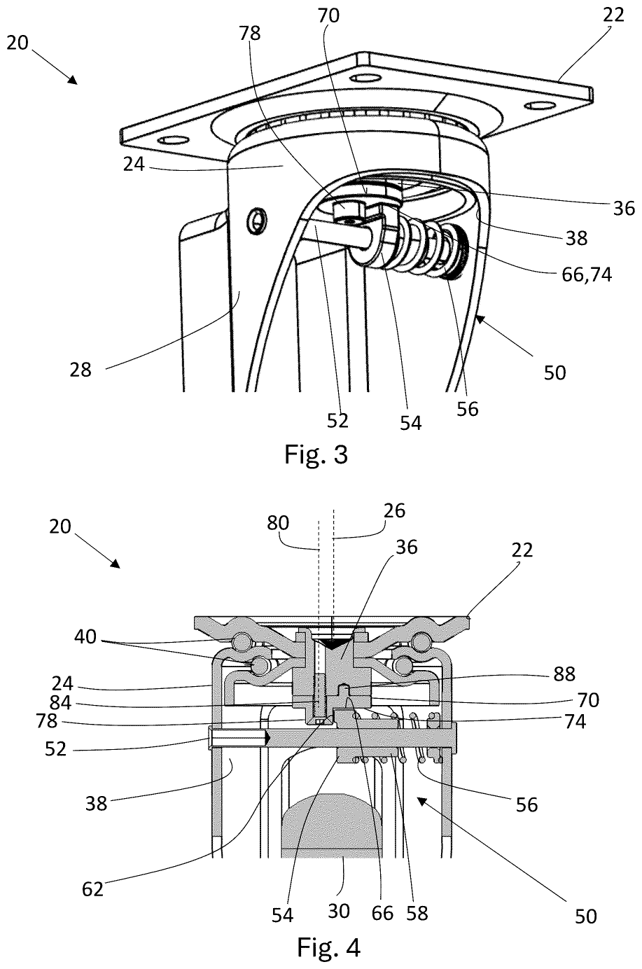

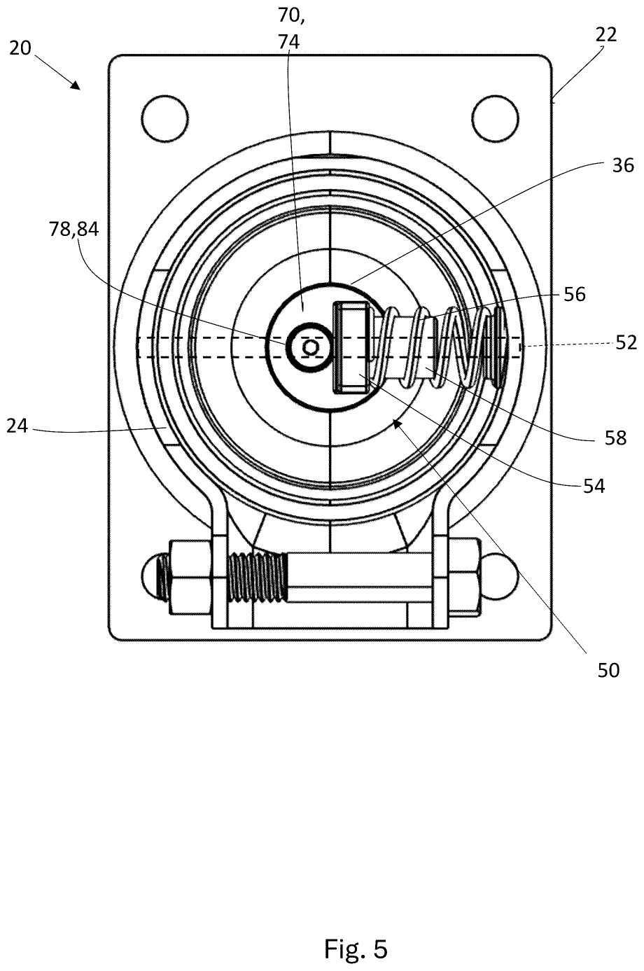

### DETAILED DESCRIPTION

The caster 20 has a mount 22 that is adapted and configured to attach the caster to an object to be moved with the caster. The mount 22 may be a top plate as shown or may be a stem. The mount 22 may be configured as needed for attachment to the object to be moved with the caster. For instance, in the configuration of the mount 22 as a top plate, the top plate may have a plurality of holes configured to receive mechanical fasteners to attach the caster to the object. In the configuration of a stem, the stem may be threaded for attachment to the object, or may be knurled for a press fit with the object.

The caster 20 may have a horn 24 that is adapted and configured to rotate relative to the mount 22 about a swivel axis 26. The horn 24 may include a fork 28 with fork portions on lateral sides of the horn and a wheel 30 may be mounted in the fork so as to be able to rotate freely about a horizontal axis 32 formed by an axle bolt 34 at a distal end of the fork. A king pin 36 may connect the horn 24 and mount 22 together in a manner so that the horn 24, the fork 28, and wheel 30 below the mount 22 and the top plate may swivel about the swivel axis 26. The king pin 36 may extend into an interior 38 of the horn 24. One or more bearings 40 may be provided between the mount 22 and the horn 24 to facilitate rotation about the swivel axis 26 and accommodate any thrust loading along the swivel axis. Within the interior 38 of the horn, an automatic alignment assembly 50 as described below is disposed.

The automatic alignment assembly 50 includes a cross rod 52 that extends from one lateral side of the horn to another lateral side of the horn. Depending upon the construction of the caster, the horn may be minimal, in which case, the cross rod 52 may extend from one lateral side of the fork to another lateral side of the fork. The cross rod 52 may be parallel to the axis of rotation of wheel 32. The cross rod 52 may be a rivet or a mechanical fastener that is fixed on lateral sides of the horn or on the fork by two nuts that cooperate with threads provided on ends of the cross rod.

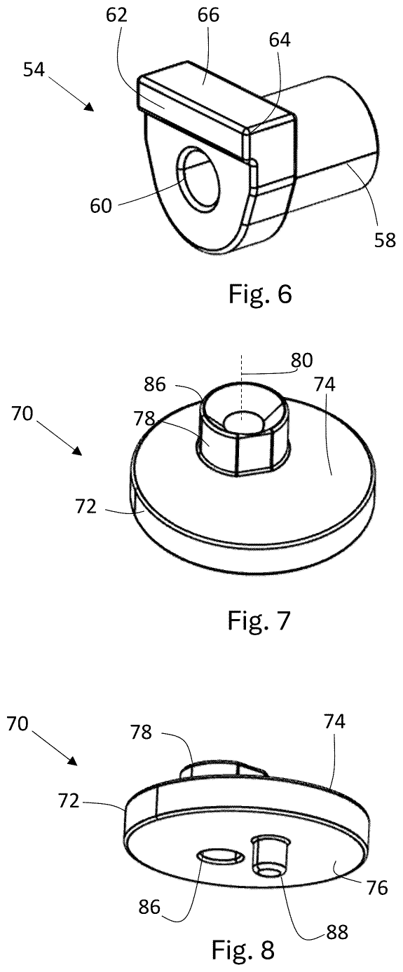

The automatic alignment assembly 50 further includes a slider 54 that is slidably mounted on the cross rod 52 and urged towards the center of the interior 38 of the horn 24 by a biasing member 56, such as a coil spring, working under compression. The biasing member 56 in the form of a coil spring may be arranged to surround the cross rod 56 and bear on a lateral face of the slider and on an internal face of the lateral side of the horn, or an internal face of a fork, as the case may be depending upon the construction of the caster 20. As best shown in FIG. 6, the slider 54 may have a cylindrical boss 58 with a through hole 60. The through hole 60 may allow the cross rod 52 to pass therethrough, and the slider 54 may slide on the cross rod 52 through the through hole 60. The cylindrical boss 58 provides a locator for an inner diameter of the coil spring 56 to support the coil spring. Opposite the cylindrical boss 58, the slider has a cam surface 62. The cam surface 62 of the slider 54 may be a flat surface arranged in a vertical plane (as shown in the drawings). The cam surface 62 may be formed on the slider 54 as shoulder 64 projecting laterally from the slider in the direction of the center axis of the through hole 60 and extending in a vertical plane above the through hole. The shoulder 64 may have a flat top surface 66 arranged perpendicular to the cam surface 62.

The automatic alignment assembly 50 further includes a camming member 70 that is attached to a distal end of the king pin 36 in the interior of the horn 38. Referring to FIGS. 7-8, the camming member 70 has a skirt 72 with a bearing surface 74 and opposite mounting surface 76. When installed, the mounting surface 76 of the skirt 72 abuts the distal end of the king pin 36, and the bearing surface 74 of the skirt 72 is exposed within the interior 38 of the horn 24. The flat top surface 66 of the shoulder 64 of the slider may have rotational sliding contact with the bearing surface 74 of the skirt 72 in the interior 38 of the horn, so as to prevent rotation of the slider 54 around the cross rod 52 and to permit the slider 54 to maintain a consistent orientation with the skirt 72 while sliding on the cross rod 52. Accordingly, the skirt 72, and in particular the bearing surface 74 of the skirt, is dimensioned to accommodate the full length of travel of the slider 54 within the interior 38 of the horn 24.

The camming member 70 includes a cam post 78 projecting from the bearing surface 74 of the skirt 72. When the camming member 70 is installed on the king pin 36, the cam post 78 has a center axis offset 80 from the center axis of the king pin, and thus, offset from the swivel axis 26 of the caster. The camming member 70 may be attached to the king pin 36 with a mechanical fastener 84. The mechanical fastener 84 may be directed through a through-hole 86 in a center of the cam post 78 into a matching hole of the king pin 36. The skirt 72 may have an anti-rotation pin 88 projecting from the mounting side 76 of the skirt. The anti-rotation pin 88 may be received in a complementary hole on the distal end of the king pin 36. The anti-rotation pin 88 may provide a counter moment to prevent any undesired rotation of the camming member 70 relative to the king pin 36.

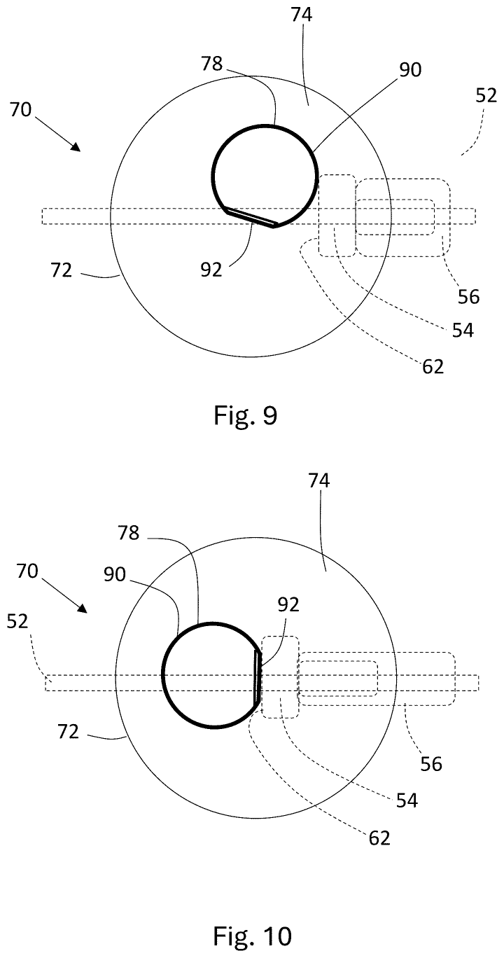

As best shown in FIGS. 9-10, the cam post 78 may have a curvilinear portion 90 and a flat portion 92. For purposes of illustration, in FIGS. 9-10, the curvilinear portion 90 is represented with a heavy line weight and the flat portion 92 is represented with a double line. The curvilinear portion 90 may be round, oval, or tear dropped shaped. Both the curvilinear portion 90 and the flat portion 92 cooperate with the cam surface 62 of the slider 54 depending upon the orientation of the wheel relative to the mount.

Under the action of the coil spring 56, the cam surface 62 of the slider 54 bears against the cam post 78 against spring pressure as the horn 24 and the fork 28 rotates about the swivel axis 26. The top surface 66 of the shoulder 64 of the slider 54 bears against the bearing surface 74 of the skirt 72 during rotation of the horn 24 and the fork 28 about the swivel axis 26 so the slider 54 is a consistent orientation relative to the cross rod 52. As the cam surface 62 of the slider 54 bears against the cam post 78, the spring 56 creates a return torque tending to bring the horn 24 and the fork 28, and thus the wheel 30 automatically back to a single, predetermined position where the flat portion 92 of the cam post 78 engages the flat cam surface 62 of the slider 54.

In particular, when the fork 28 is not in the single predetermined orientation relative to the mount 22 (not with the flats 62,92 aligned), the cam surface 62 of the slider 54 is urged by the coil spring biasing member 56 against the curvilinear portion 90 of the cam post 78 as shown in FIG. 9. When the fork 28 is in the single predetermined orientation relative to the mount 22, the cam surface 62 of the slider 54 is urged by the coil spring biasing member 56 against the flat portion 92 of the cam post 78 as shown in FIG. 10, which may be with less compression spring force than when the cam surface of the slider is urged by the coil spring biasing member against the curvilinear portion of the cam post as shown in FIG. 9. More in particular, as shown in FIG. 10, the flat portion 92 of the cam post 78 provides positive engagement of the slider 54 with the cam post 78 and thus a more precise direction location of the horn 24 relative to the mount 22 in the desired single, predetermined orientation and enhanced repeatability in automatic alignment.

Further embodiments can be envisioned by one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, various modifications and changes may be made thereunto without departing from the broader spirit and scope of the invention as set forth in the claims and that the invention is intended to cover all modifications and equivalents within the scope of the following claims.

What is claimed is:

1. A caster comprising:
a mount;
a fork adapted and configured for rotation relative to the mount about a swivel axis;
a wheel rotatably mounted in the fork; and
an automatic alignment assembly adapted to pivot the fork and the wheel of the caster to a single, predetermined orientation relative to the mount, the automatic alignment assembly being operatively connected to the fork, the automatic alignment assembly comprising:
a cross rod extending from one side of the fork to an opposite side of the fork;
a slider adapted and configured for sliding on the cross rod, the slider having a flat cam surface;
a biasing member adapted and configured to urge the slider away from a side of the fork; and
a camming member operatively connected to the mount, the camming member having a cam post, the cam post extending from the camming member in a manner offset from the swivel axis, the cam post having a curvilinear portion and a flat portion;
wherein when the fork is not in the single predetermined orientation relative to the mount, the cam surface of the slider is urged by the biasing member against the curvilinear portion of the cam post; and
wherein when the fork is in the single predetermined orientation relative to the mount, the cam surface of the slider is urged by the biasing member against the flat portion of the cam post.

2. The caster of claim 1 wherein the biasing member comprises a coil spring.

3. The caster of claim 2 wherein the slider includes a boss with a through hole, the cross rod extends through the through hole and the coil spring is supported on the boss.

4. The caster of claim 1 further comprising a king pin connected to the mount and rotatable relative to the fork.

5. The caster of claim 4 wherein the camming member is mounted to a distal end of the king pin.

6. The caster of claim 5 wherein a mechanical fastener extends through the cam post through the camming member and into the king pin in mounting the camming member to the distal end of the king pin.

7. The caster of claim 4 wherein the cam post projects away from a distal end of the king pin.

8. The caster of claim 4 wherein the camming member includes a skirt extending about a distal end of the king pin.

9. The caster of claim 8 wherein the skirt has a bearing surface that engages the slider.

10. The caster of claim 9 wherein the slider has a flat surface orthogonal to the cam surface that engages the bearing surface of the skirt.

11. The caster of claim 9 wherein the skirt has a mounting surface opposite of the bearing surface, the mounting surface includes an anti-rotational pin projecting therefrom, the anti-rotational pin is received in a complementary hole on the distal end of the king pin.

12. A caster comprising:
a mount;
a horn adapted and configured for rotation relative to the mount about a swivel axis, the horn having an interior;
a fork depending from the horn;
a wheel rotatably mounted in the fork; and
an automatic alignment assembly adapted to pivot the horn, fork and the wheel of the caster to a single, predetermined orientation relative to the mount, the automatic alignment assembly being disposed in the interior of the horn, the automatic alignment assembly comprising:
a cross rod extending from a lateral side of the horn to an opposite lateral side of the horn;
a slider adapted and configured for sliding on the cross rod, the slider having a flat cam surface;
a biasing member adapted and configured to urge the slider away from a lateral side of the horn; and
a camming member operatively connected to the mount, the camming member having a cam post, the cam post extending from the camming member in a manner offset from the swivel axis, the cam post having a curvilinear portion and a flat portion;
wherein when the fork is not in the single predetermined orientation relative to the mount, the cam surface of the slider is urged by the biasing member against the curvilinear portion of the cam post; and
wherein when the fork is in the single predetermined orientation relative to the mount, the cam surface of the slider is urged by the biasing member against the flat portion of the cam post.

13. The caster of claim 12 wherein the biasing member comprises a coil spring.

14. The caster of claim 13 wherein the slider includes a boss with a through hole, the cross rod extends through the through hole and the coil spring is supported on the boss.

15. The caster of claim 12 further comprising a king pin connected to the mount and rotatable relative to the horn.

16. The caster of claim 15 wherein the camming member is mounted to a distal end of the king pin.

17. The caster of claim 16 wherein a mechanical fastener extends through the cam post through the camming member and into the king pin in mounting the camming member to the distal end of the king pin.

18. The caster of claim 15 wherein the cam post projects away from a distal end of the king pin.

19. The caster of claim 14 wherein the camming member includes a skirt extending about a distal end of the king pin.

20. The caster of claim 19 wherein the skirt has a bearing surface that engages the slider.

21. The caster of claim 20 wherein the slider has a flat surface orthogonal to the cam surface that engages the bearing surface of the skirt.

22. The caster of claim 21 wherein the skirt has a mounting surface opposite of the bearing surface, the mounting surface includes an anti-rotational pin projecting therefrom, the anti-rotational pin is received in a complementary hole on the distal end of the king pin.
